(19) United States
(12) Patent Application Publication
(10) Pub. No.: US 2011/0219933 A1
(43) Pub. Date: Sep. 15, 2011

(54) MUSICAL STRING

(75) Inventor: Franz Klanner, Wien (AT)

(73) Assignee: Thomastik-Infeld Gesellschaft m.b.H., Wien (AT)

(21) Appl. No.: 13/044,983

(22) Filed: Mar. 10, 2011

Related U.S. Application Data
(60) Provisional application No. 61/312,408, filed on Mar. 10, 2010.

(30) Foreign Application Priority Data
Mar. 10, 2010 (AT) A 387/2010

(51) Int. Cl. G10D 3/10

(52) U.S. Cl. 84/297 S

(57) ABSTRACT

A musical string includes at least one supporting core of the string, and a first winding wire wound in a helical manner around the core of the string. The first winding wire has a core and a first outside layer disposed in substantial surrounding relationship to the core. The core and the first outside layer are pressed and/or welded together at least in sections.

### CROSS-REFERENCES TO RELATED APPLICATIONS

This application claims the benefit of prior filed U.S. Provisional Application No. 61/312,408, filed Mar. 10, 2010, pursuant to 35 U.S.C. 119(e).

This application also claims the priority of Austrian Patent Application, Serial No. A 387/2010, filed Mar. 10, 2010, pursuant to 35 U.S.C. 119(a)-(d).

The contents of U.S. Provisional Application No. 61/312,408 and Austrian Patent Application, Serial No. A 387/2010 are incorporated herein by reference in its entirety as if fully set forth herein.

### BACKGROUND OF THE INVENTION

The present invention relates to a musical string

The following discussion of related art is provided to assist the reader in understanding the advantages of the invention, and is not to be construed as an admission that this related art is prior art to this invention.

Music strings are known which have a core of a string and at least one winding. The core of such music strings substantially absorbs the forces which prevail in a tensioned music string. The core of the string is usually highly tensioned and, in the sound post of the musical string, is usually operated in the range of its yield point.

The winding differs from the core of the string in such a way that it will not absorb or transmit any longitudinal forces of the tensioned musical string. It is the primary object of the winding to increase the mass coating of the musical string without increasing the force-absorbing cross-section and, in this process, the bending stiffness of the core of the string should be increased as little as possible. It is therefore known to arrange the winding in the form of a winding wire which is wound in a helical manner around the core of the string. As a result of the winding wire that is arranged in a helical manner it can be achieved that although the mass of the musical string per unit of length (mass coating) is increased, at the same time substantially no forces are absorbed during the tensioning of the musical string.

In addition to the use of winding wires which are arranged as blank metal wires it is further known to coat such winding wires. Coating with a plastic lacquer is known and furthermore a thin metal coating which is vacuum-deposited onto the winding wire or electroplated thereon. Such coatings are provided to ensure that direct contact between the winding wire and the ambient environment is prevented. The winding wire is to be protected from corrosion and the occurrence of allergies in the musicians is to be prevented. Furthermore, such coatings are often only provided to determine the visual appearance of the musical string, e.g. by chemical vapor deposition with gold or silver.

The disadvantageous aspect in musical strings with winding wires coated in this manner is that such known coatings have an only very low resistance to wear. Especially the excitation of the musical string by strokes of the bow and the gripping of the musical string by the fingers quickly leads to “abrasion” of the coating of the winding wire. In addition to an undesirable visual appearance of the musical string, this can lead to corrosion of the winding wire and possibly also to the occurrence of contact allergies in respectively sensitive musicians. As a result of the different surface conditions at different locations in such a case, the musical strings have a different response in such a state depending on the point of excitation by the bow. The respective musical string will therefore be excited in a different amount by the bow depending on the state of the surface at the point where the bow is applied. The musical string therefore not only has different handling properties but also a different tonal richness. Moreover, such impaired musical strings are no longer harmonically pure. This can lead to the non-playability of the respective musical string which then needs to be replaced by the musician.

The nature and configuration of the winding wire directly influences the tone and handling of a musical string. Known musical strings with known winding wire have the further disadvantage of only very limited possibilities of influencing the tone or controlling the tone with such known winding wire because not all materials are suitable as a material for a winding wire. Desired properties of a winding wire cannot be achieved with materials which are actually suitable for this application. As a result, musical strings with specifically desired acoustic properties cannot be produced according to the known state of the art. The respectively desired acoustic properties of a musical string vary according to its intended purpose, which means whether a musical string is intended for excitation by stroking or plucking, whether the respective musical string is used for classical music, pop or jazz, etc.

It would therefore be desirable and advantageous to provide an improved musical string which obviates prior art shortcomings and which is stable over a long period of time and offers further possibilities of constructively influencing the tone and/or the handling of the musical string.

### SUMMARY OF THE INVENTION

According to one aspect of the present invention, a musical string includes at least one supporting core of the string, and a first winding wire wound in a helical manner around the core of the string, said first winding wire having a core and a first outside layer disposed in substantial surrounding relationship to the core, wherein the core and the first outside layer are pressed and/or welded together at least in sections.

It is thus possible to apply an outside layer onto the core which is considerably thicker than is possible in conventionally coated winding wires. In this way it is possible to create a musical string whose externally accessible regions permanently show constant properties. A musical string can thus be created which offers substantially identical musical properties over a long period of time. As a result, the contact of the core of a winding wire can securely be prevented with the ambient environment, especially the fingers of a musician and/or a bow.

It is thus possible to use pairings of materials between the core and the outside layer which are not possible with known coating methods, especially coatings by electroplating or a vacuum deposition. The new possible pairings of materials provide further possibilities for influencing the tone or the playing properties of the musical string already during its construction and configuration.

The acoustic phenomena such as transmission and reflection of vibrations occurring at the boundary surfaces between the core and the outside layer can be utilized by the manner of the connection of the core with the outside layer and the larger thicknesses of the outside layer in comparison with the known coatings in winding wires. As a result, the damping of the musical string which can be achieved by the winding can be adjusted precisely and in a predeterminable manner to the desired results. Winding wires with previously unknown physical parameters in musical strings can be created with the now possible novel pairings of materials. For example, a winding wire can be formed which has a specific weight which substantially can be freely chosen via the pairing of the materials. It is thus possible to form for the first time a winding wire for musical strings, the specific weight of which lies in a freely predetermined manner between the specific weight of aluminum and platinum.

Furthermore, the damping of the musical string can be influenced in a predeterminable manner because winding wires are thus enabled which have a defined inner damping in a defined frequency range. It is thus optionally possible to omit further damping means in the musical string such as oils and/or waxes, which are arranged otherwise in the intermediate spaces between the individual windings of the first winding wire. This simplifies the production process in producing the musical string and the tolerances within a production batch can be reduced because it is possible to omit the additional damping means.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic view of a musical string;

FIG. 2 shows a schematic view of a section of a musical string in accordance with the invention with first and second winding wires shown in a cross sectional illustration;

FIG. 3 shows a sectional view of a first embodiment of a first winding wire;

FIG. 4 shows a sectional view of a second embodiment of a first winding wire;

FIG. 5 shows a sectional view of a third embodiment of a first winding wire;

FIG. 6 shows a sectional view of a fourth embodiment of a first winding wire.

### DETAILED DESCRIPTION OF PREFERRED EMBODIMENTS

Throughout all the figures, same or corresponding elements may generally be indicated by same reference numerals. The various embodiments shown in the drawings are illustrated in the form of a simplified illustration. The proportions need not correspond to the intended real proportions. Individual parts may be shown in a highly enlarged illustration for the purpose of better understanding. Individual drawings can show embodiments of musical strings 1 that do not show all features relevant to the invention if this is useful for the purpose of a better and clearer illustration, with such illustrations or embodiments thereby not contradicting the invention.

FIG. 2 shows a schematic illustration of an especially preferred embodiment of a musical string 1, especially for string instruments and/or plucked instruments, with the musical string 1 comprising at least one supporting core 2 of the string, and with a first winding wire 3 being wound in a helical manner around the core 2 of the string, with the first winding wire 3 having a core 4 and the first outside layer 5, and with the core 4 being surrounded substantially completely by the first outside layer 5, and the core 4 and the first outside layer 5 being pressed and/or welded together at least in sections.

In this way it is possible to apply an outside layer onto the core 4 which is considerably thicker than is possible in conventionally coated winding wires. It is thus possible to create a musical string 1, the outside accessible regions of which will permanently have constant properties. A musical string 1 can thereby be created which shows substantially identical musical properties over a long period of time. In this way, contact of the core 4 of the first winding wire 3 with the ambient environment, especially the fingers of a musician and/or a bow, can be prevented securely.

Pairings of material between the core 4 and the first outside layer 5 can thereby be used, which pairings are not possible with known coating methods, especially coatings by electroplating or vacuum deposition. The new possible pairings of materials provide further possibilities for influencing the tone or the playing properties of the musical string 1 already during its construction and configuration. The acoustic phenomena such as transmission and reflection of vibrations occurring at the boundary surfaces between the core 4 and the first outside layer 5 can be utilized by the manner of the connection of the core 4 with the first outside layer 5 and the larger thicknesses of the outside layer 5 in comparison with the known coatings in winding wires. As a result, the damping of the musical string 1 which can be achieved by the winding can be adjusted precisely and in a predeterminable manner to the desired results. Winding wires 3, 7 with previously unknown physical parameters in musical strings 1 can be created with the now possible novel pairings of materials. For example, a winding wire 3, 7 can be formed which has a specific weight which substantially can be freely chosen via the pairing of the materials. It is thus possible to form for the first time a winding wire 3, 7 for musical strings 1, the specific weight of which lies in a freely predetermined manner between the specific weight of aluminum and platinum.

Furthermore, the damping of the musical string 1 can be influenced in a predeterminable manner because winding wires 3, 7 are thus enabled which have a defined inner damping in a defined frequency range. It is thus optionally possible to omit further damping means in the musical string 1 such as oils and/or waxes, which are arranged otherwise in the intermediate spaces between the individual windings of the winding wires 3, 7. This simplifies the production process in producing the musical string and the tolerances within a production batch can be reduced because it is possible to omit the additional damping means.

A preferred field of use for such musical strings 1 is the instruments of the family of violins such as the violin, viola, cello and bass and contrabass. Further preferred instruments for use of the musical strings 1 in accordance with the invention are guitars and mandolins. Such musical strings 1 in accordance with the invention can principally be provided for all stringed and plucked instruments such as cembalos, harps, banjos, sitars, dulcimers, zithers, lutes, oods, p'i-p'as, gekkins, balalaikas, vinas, tampuras, kotos, sohs, etc.

Musical strings 1 in accordance with the invention are provided for generating sound-making oscillations, with a specific musical string 1 being provided for use in a specific musical instrument such as a 4/4 violin and further having a concert pitch and sound post as features, with the concert pitch determining the sound with which a portion of the musical string 1 will oscillate (between its end sections) from the length 8 of the scale of the musical instrument for which it is provided when the musical string 1 is loaded with the sound post and is therefore tensioned.

As already mentioned above, it is differentiated in musical strings 1 between the core 2 of the string and the winding, which in the present case are formed as winding wires 3, 7. The core 2 substantially carries the entire load or tension of the musical string 1. Merely the cross-section of the core 2 therefore carries the sound post of a respective tune of a musical string 1. The core 2 of the string is preferably arranged as a metallic single wire, preferably comprising steel, or as a strand of a pre-determinable number of synthetic fibers, or as a wire rope or a twisted strand of natural gut.

It is the object of the winding to increase the mass coating, therefore the mass of the musical string per unit of length. The frequency with which the musical string 1 will vibrate after or during its excitation depends in addition to the length of the vibrating part of the musical string 1 (which can be reduced by gripping tone), on the force with which the musical string 1 is tensioned (which is designated by the person skilled in the art as the sound post), and its mass per unit of length. Since an increase of the mass by increasing the cross-section of the core 2 of the string will not lead to satisfactory results in order to reduce the frequency of the tone-producing vibration of the musical string 1, it has proven to be advantageous to wind at least one winding wire 3 around the core 2 of the string in a helical manner. The helical arrangement of the winding wire 3, 7 can ensure that it will not absorb any longitudinal forces of the musical string and that it will also prevent increasing the bending stiffness of the musical string 1. Musical strings with a winding wire 3, 7 usually comprise between one and up to six or more layers of the winding wire 3, 7. It can also be provided that several such winding wires 3, 7 are arranged adjacent to one another. Winding wires 3, 7 preferably have a substantially circular or rectangular cross-section. Furthermore, cross sections are provided with respective mixed forms such as rectangles with rounded off edges.

As has already been explained initially, it is known that the first winding wire 3 has a core 4 and a first outside layer 5, and that the core 4 is surrounded substantially completely by the first outside layer 5. Such known outside layers are arranged as a plastic coating or as a vapor-deposition or coating by electroplating with a metal, with the metal layer having a maximum thickness of 5 μm. Such a metal layer is too thin however in order to have a considerable vibratory effect.

It is further provided according to a preferred embodiment of a musical string 1 in accordance with the invention that at least one second outside layer 6 substantially completely surrounds the first outside layer 5. This allows further influencing the effect of the winding wire 3, 7 on the tone of the musical string 1. In particular, the damping and the density of the winding wire 3, 7 can be adjusted further in a predeterminable manner.

FIG. 6 shows a preferred embodiment of a winding wire 3, 7 with a core 4, an outside layer 5 which in this embodiment can also be designated as an intermediate layer, and a second outside layer 6. FIG. 6 shows a sectional view of a merely schematic illustration. The boundary fibers of the individual areas of the core 4, first outside layer 5 and second outside layer 6 usually deviate from the illustrated idealized rectangular form in the case of actual embodiments. Notice must be taken that the connection of the core 4 with the first outside layer 5 in accordance with the invention will deviate considerably from the known electric or chemical coatings of the core 4 as a result of the boundary fiber forms which can also be designated as the boundary layer or boundary regions. Furthermore, the second outside layer 6 usually has a cross-section which will deviate from the illustrated rectangular cross-section, in that it will have rounded edges or so-called natural edges, as are produced during a rolling process.

It can further be provided in a further development of the present invention that a further third outside layer is arranged on the second outside layer 6 which substantially completely surrounds the second outside layer 6 and is arranged according to the present invention. It is also possible to provide further additional outside layers in accordance with the invention.

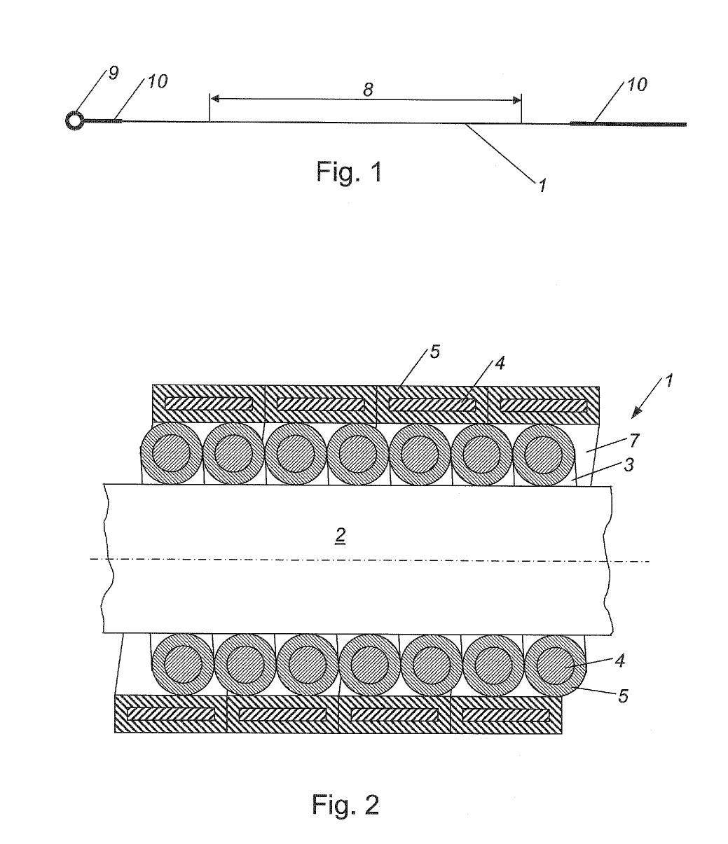

Musical strings 1 generally have a means for mounting the musical string 1 on a part of the respective musical instrument. This means for mounting can be formed in simple embodiments by a loop or a knot in the musical string 1. It is preferably provided that the musical string 1 is delimited at a first end by a sleeve or a ball 9 which especially comprises metal and which is generally also designated as ball 9. The musical string 1 further comprises preferably at least at one end a so-called wrapping 10. It is especially preferably provided that the musical string 1 comprises one wrapping 10 each at its two ends which protect the musical string 1 from excessive edge load during mounting on the pegs of a musical instrument. The wrappings 10 which are often arranged in colors are preferably made of artificial and/or natural fibers. FIG. 1 shows a schematic illustration of such a musical string 1.

It is provided in accordance with the invention that the core 4 and the first outside layer 5 are pressed and/or welded together at least in sections, through which the advantages and effects already explained above can be achieved. It is further provided according to a preferred embodiment that if a second outside layer 6 is present said second outside layer 6 is also pressed and/or welded together with the first outside layer 5 at least in sections. According to an especially preferred embodiment of the present invention it is further provided that the core 4 and the first outside layer 5, and/or the first outside layer 5 and the second outside layer 6 are pressed and/or welded together substantially over their entire length and their entire circumference.

Any respectively suitable method can preferably be provided for pressing and/or welding the first outside layer 5 with the core 4 and/or the second outside layer 6 with the outside layer 5. It has proven to be especially advantageous, both for the production of the winding wires 3, 7 as well as for their acoustic effects, that the core 4 and the first outside layer 5 as well as the first outside layer 5 and the second outside layer 6 are pressed and/or welded together by a mechanical forming method. Especially plating and/or drawing and/or rolling and their mixed forms such as roll-bonding, draw-bonding and the like have proven to be especially advantageous for the production of respectively arranged winding wires 3, 7. According to an especially preferred method for producing respective winding wires 3, 7 for musical strings 1 in accordance with the invention, the repeated drawing of a metal tube is provided which forms the outside layer 5, together with a cylinder fitted into its interior or another filling that will be described below, by a number of drawing dies. The round wire thus formed can thus already be used as a winding wire 3, 7 for a musical strings 1 in accordance with the invention, or it can subsequently be flat-rolled into a flat wire if this is preferable for a musical string 1. Such a flat-rolled winding wire 3, 7 is also known as a strip. It is preferably provided that such a strip is between 1.1 and 30 times as wide as it is thick. It can also be provided to sand down or grind a winding wire 3, 7 after its arrangement on a musical string for example, so that it is provided with a cross-section which is arranged in a straight manner in sections. This is preferable in the case of guitar strings for example in order to reduce noises which would otherwise be produced by drawing the finger along the musical string.

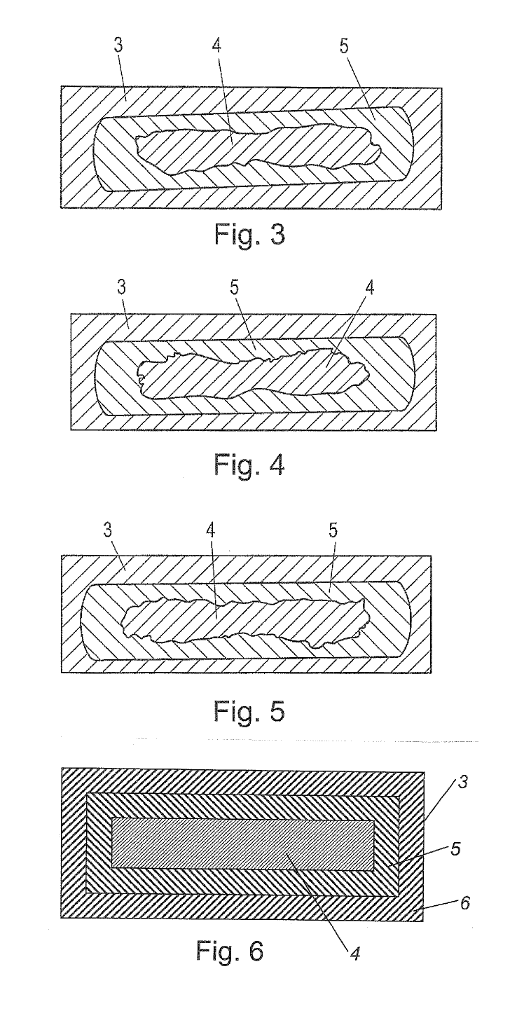

The initially explained effects are achieved by the manner of the connection of the first outside layer 5 with the core 4, with the production of the winding wire 3, 7 having proven to be especially advantageous as a result of the illustrated preferred forming methods. It was surprisingly noted that especially with respectively produced winding wires 3, 7 it was possible to create especially musical strings rich in tonal color with excellent response and control. The type of production of the winding wire 3, 7 on the basis of the initially explained preferred methods can be attributed unequivocally to the so-called boundary fiber forms, e.g. by examination with a reflected-light microscope. The term of boundary fiber form relates in this respect to the boundary region between the core 4 and the first outside layer 5, or between the first outside layer 5 and the second outside layer 6. FIGS. 3, 4 and 5 show sectional views of preferred embodiments of winding wires 3, 7 for musical strings 1 in accordance with the invention. The frayed boundary fiber forms can be recognized clearly and specifically. A broadband damping behavior can be achieved to a certain extent by the frayed boundary fibers, which behavior has a low vibratory quality. As a result, the respective quality acts directly already after the excitation of the musical string 1. A too high quality would lead to the consequence that the respective effect would achieve its full effect only after a certain excitation duration.

Preferred embodiments of a first winding wire 3 will be described below in closer detail. The described embodiments can be applied to any winding wire 3, 7 of a musical string 1 in accordance with the invention. It can also be provided that a musical string 1 in accordance with the invention comprises both conventionally arranged winding wires as well as winding wires 3, 7 as described according to the present invention.

It is preferably provided that the first outside layer 5 and/or the second outside layer 6 has a thickness of between 8 μm and 300 μm, especially between 10 μm and 100 μm, preferably between 25μ and 70 μm. Coatings of such thickness come with the advantage that they are considerably more durable in comparison with thinner coatings. Furthermore, such thick coatings have a higher acoustic effect because the path which is covered by the structure-borne sound waves within one layer up to the next reflection on a boundary surface is larger and furthermore the influence of the coating on the total density of the winding wire 3, 7 is considerably higher than in known winding wires as a result of the larger thickness.

It is preferably provided that the first outside layer 5 and/or the second outside layer 6 is arranged to comprise a metallic material. This combines the advantages of high density and a rough surface which is advantageous for the excitation by a bow because colophony adheres especially well on such a rough surface. Furthermore, many metals are abrasion-resistant. According to the especially preferred embodiments of a musical string in accordance with the invention it is preferably provided that the first outside layer 5 and/or the second outside layer 6 comprises at the least one metal chosen from the group of aluminum and/or gold and/or silver, preferably silver with a purity level of 99.999% or 99.6%, and/or rhodium and/or palladium and/or platinum and/or rhenium and/or tantalum and/or titanium and/or nickel. Alloys comprising at least one of these mentioned preferred materials are preferably provided, especially alloys of aluminum and magnesium, alloys of aluminum, magnesium and manganese, alloys of silver and copper, especially AgCu, AgCu 2, AgCu 6, alloys of silver and platinum such as AgPt 16, alloys of silver and rhodium such as AgRh 16, alloys of silver and palladium, alloys of iron, chromium, nickel, silicon and aluminum, alloys of nickel and iron. Further preferred are so-called shape memory alloys chosen from the group of nickel and titanium, copper and zinc, copper, zinc and aluminum, copper, aluminum and nickel, iron, nickel and aluminum, nickel, titanium and iron, nickel, titanium and copper, copper, zinc and silicon, copper, zinc and gallium, indium and titanium, gold and cadmium, and/or expansion alloys for use in the outside layer 5 and/or the second outside layer 6.

The core 4 of the first winding wire is arranged within the first outside layer 3. It is preferably provided that the thickness or diameter of the core 4 is between 0.8 and three times the thickness of the first and/or the second outside layer 5, 6. Whereas the first or second outside layer 5, 6 is preferably arranged to comprise at least one metal, the core 4 is preferably arranged in a different manner according to the preferred embodiment as described below. Any combination of any of the described embodiments can be provided with any of the described embodiments of a first and/or second and/or further outside layer 5, 6.

According to a first preferred embodiment of a core 4 of a first winding wire 3 it is provided that the core 4 is arranged as a massive single core comprising plastic, with preferably a respectively drawable plastic being provided such as PA, PAS, PE, PP, PEEK, PEK, PET, PEET or the like. This comes with the advantage of a low density of the core 4. The core 4 further has a structure-borne speed of sound which is highly different from that of the metal of the first outside layer, so that good damping can be achieved on the boundary fibers.

According to a second preferred embodiment of a core 4 of a winding wire 3, 7 it is provided that the core 4 is arranged as a massive single core comprising metal, with especially at least one metal being provided which is chosen from the group of aluminum and/or nickel and/or copper and/or tungsten and/or iron and/or lead and/or thallium and/or silver and/or titanium and/or iridium. Alloys of respective materials are also provided, e.g. nickel base alloys such as NiFe42 or also alloys with a nickel content of 99.2% or 99.6%. The damping of winding wires formed in this way is lower than in a core made of plastic. The density is considerably higher at the same time. Such winding wires are advantageous for forming bass strings which are to be excited by plucking and therefore require a lower damping than strings for string instruments, and can preferably be used for use in double basses for jazz musicians. A core 4 made of a ferromagnetic material comes with the further advantage that an electromagnetic pickup can be used in the musical instrument without any further aiding means.

It can further be provided that the core 4 has at least one shape memory alloy and/or an expansion alloy. Reference is hereby made to the examples above concerning the first and second outside layer 5, 6, with the effects as mentioned below also applying to respectively arranged first and second outside layers 5, 6. The relationship of the mechanical tensions between these individual elements can be influenced in a predeterminable manner by using such alloys in core 4 or the first and/or second outside layer 5, 6. These individual elements can thus be pretensioned in a predeterminable manner for example. This pretensioning can be set in such a way that it is relieved for example at a predetermined elongation of the musical string. It can also be predetermined in such a way that the pretensioning occurs only from a certain elongation. Vibratory properties of the musical string can thus be achieved which are dependent on the oscillation amplitude. A musical string can thus be formed which can be excited in a very finely differentiated manner at low oscillation amplitudes and with which very large oscillation amplitudes can be achieved in a very simple way. Since the oscillation amplitude of the musical string is proportional to the volume produced by the musical instrument, a musical string can be created whose excitability or playing properties are adjusted to the loudness sensitivity of the ear, especially the human ear. The human ear has better resolution properties at low volumes than high volumes.

It is preferably provided in the arrangement of core 4 according to the first and/or second embodiment that the core 4 has a circular, elliptical or a polygonal cross-section. It is especially also possible that mixed forms of these cross-sectional shapes can be provided. It can also be provided that a plurality of massively arranged cores 4, e.g. two, three or four thereof, according to the first and/or second embodiment are arranged next to one another, thus forming a core 4. It can be provided that intermediate spaces between these individual parts are filled by the first outside layer 5.

It is provided according to a third preferred embodiment of a core 4 of a first winding wire 3 that the core 4 comprises a predeterminable number of fibrous and/or wire-like core elements. These core elements, which are not shown in the drawings, are preferably arranged as plastic fibers and/or metal fibers, with preferably the use of the above described metals or alloys containing the same being provided. Reference is hereby made to the above first preferred embodiment of a core concerning the preferred plastic materials. It is also provide in particular to mix fibrous and/or wire-like core elements made of plastic and metal into a single core 4. When the musical string 1 is deflected from its idle position, shearing forces occur on the boundary surfaces of the fibers which ensure a high level of inner damping of musical strings 1 formed in this manner. Furthermore, the density of the winding wire 3, 7 which is formed in this manner can be set very precisely and can be adjusted to the respective requirements by a variation of the content of plastic materials and metals.

It is provided according to a fourth preferred embodiment of a core 4 of a first winding wire 3 that the core 4 is arranged as a rope. This can also be designated as a further development of the third preferred embodiment of a core 4, with the materials, arrangements and effects as mentioned above also being asserted for the fourth preferred embodiment. The arrangement of the core 4 as a rope comes with a further advantage of simpler handling and simpler production because a rope can be processed more easily than a plurality of thin individual fibers. Moreover, the inner damping in the core can be increased even further by a rope.

It is provided according to a fifth preferred embodiment of a core 4 of a first winding wire 3 that the core 4 comprises a granulate, especially comprising plastic and/or metal, preferably a plastic granulate and/or a metal granulate. Such a granulate has a plurality of different grain boundaries between mutually adjacent grains of the granulate. As a result of this high number of boundary surfaces, such a core has an especially high inner damping because not only reflection and transmission of the structure-born sound waves occur on each boundary surface but also high shearing forces which act in a damping fashion during each vibration process of the musical string 1. Preferably, at the least each of the above-mentioned metals can be provided and further at least one plastic chosen from the group of PA, PMMA, PE, PP, ABS, PVC, POM, PEEK, PTFE, FUR, PC, CA, CAB, PET, PETP, PS, SB, SAN. It is further preferably provided that the granulate comprises plastic and metal, so that especially high damping can be achieved. The granular arrangement of the core comes with the further advantage that the number of useful materials can be increased considerably because brittle materials and such with low drawability such as iridium or osmium can be used.

It is provided according to a sixth preferred embodiment of a core 4 of the first winding wire 3 that the granulate comprises at least one capsule, especially a micro-container and/or a nano-container, and that at least one fluid, especially a polymer one, is arranged in the interior of the capsule. It is especially provided that the at least one capsule is arranged in such a way that it will break open after a substantially predeterminable period of time and/or under substantially predeterminable loading states, and supplies its content to the ambient environment. The fluid which is arranged in the capsule preferably concerns a polymer fluid, especially an oil or resin. It is provided in an especially preferred manner that a plurality of differently filled capsules is arranged in the core 4 or form the same. It can be provided for example to arrange a resin and a hardener in different capsules. Such capsules, especially micro-containers and/or nano-containers, are known from the cosmetics industry. This can help counteract age-related changes to the musical string, in that the capsules release their content after a predeterminable loading period.

As already explained above, it is preferably provided that each of the described six preferred embodiments is combined with a first and/or second and/or further outside layer 5, 6, and each of the provided winding wires 3, 7.

It can further be provided in a core according to the first, second, third and/or fourth embodiment that such a core 4 comprises an electrically and/or chemically applied coating at least in sections. Such a coating, which has the initially mentioned disadvantages in its application as an outer coating, can still have other acoustic effects on the boundary surface between the core 4 and the first outside layer 5. As a result of the thin electrically and/or chemically applied coating on the boundary surface between the core 4 and the first outside layer 5 there will be a further splitting of a structure-borne sound wave into reflection and transmission on the boundary surface between the core 4 and the first outside layer 5, through which it can be further dampened in a predeterminable manner. Such a coating is not mechanically stressed at this place by the fingers or the bow and is therefore more durable as an outside coating. Such a thin electrically and/or chemically applied coating is considered in this case as a part of the core 4. It can be provided that this coating is torn open during the production process of the winding wires 3, 7 and the non-coated core acts directly on the first outside layer in sections.

It can be provided according to a further preferred embodiment of a musical string 1 in accordance with the invention that a polymer, especially a lacquer and/or a resin, is arranged in sections between the core 4 and the first outside layer 5 and/or between the first outside layer 5 and the second outside layer 6. It is especially provided that before the mechanical production process of the winding wire 3, 7 an adhesive and/or a lacquer is arranged between the core and the first outside layer 5 and/or between the first outside layer 5 and the second outside layer 6, and that this composite is subsequently drawn and/or rolled. This process leads to the tearing open of the adhesive or lacquer in sections and to the connection in accordance with the invention between mutually adjacent parts. The polymer is further arranged or surrounded in sections between the areas thus connected. The absorption spectrum of the winding can thus be provided with a more broadband configuration in this way.

The damping that can be achieved by the winding wires 3, 7 comes especially with the advantages that in this way it is possible to dampen both the disturbing torsional oscillations which lead to response problems in the excitation by the bow and to longitudinal oscillations which are responsible especially for a sound of conventional musical strings which is perceived as rough and off-tune.

Especially preferred pairings of materials between the core 4 and first outside layer 5 are described below. These pairings of materials have proven to be especially advantageous up until now irrespective of the concrete arrangement of the core 4:

| Core: | First outside layer: |
|---|---|
| Aluminum | Gold |
| Nickel | Silver |
| Copper | Silver |
| Tungsten | Silver |
| Aluminum | Silver |
| Aluminum | Titanium |
| Aluminum | Rhodium |
| Aluminum | Platinum |
| Nickel | Platinum |
| PVC | Silver |
| PEEK | Silver |
| Soft iron | Palladium |
| Soft iron | Silver |
| Tungsten | Gold |
| Silver | Gold |
| AgNi99.6 | AgCuNi (Sterling silver) |

The mentioned materials shall be understood in such a way that the core 4 or the outside layer 5 have the respective material as a relevant component, but need not necessarily be formed entirely from such a material or be free from other materials.

It can especially also be provided that the core 4 and the first outside layer 5, or the first outside layer 5 and the second outside layer 6, have substantially identical materials which were given different heat treatments before the production of the winding wire 3, 7 however.

FIG. 2 shows one example of a preferred embodiment of a musical string 1 in accordance with the invention, with the winding wires 3, 7 being shown in a sectional view. The core 2 of the string is formed according to the illustrated embodiment to comprise a bundle of thin plastic fibers, e.g. comprising PA 6.10. The first winding wire 3 is arranged as a round wire, with the core of the first winding wire 3 being arranged to comprise aluminum, and the first outside layer 5 of the first winding wire 3 comprising silver. The musical string 1 according to FIG. 2 further comprises a second winding wire 7 which is arranged as a flat wire or strip. The core 4 of the second winding wire 7 is arranged to comprise nickel, and the first outside layer comprises silver. The first winding wire 3 and the second winding wire 7 are arranged to cross one another in a helical manner. It is optionally possible to omit the use of further damping agents such as oil and/or wax in such a musical string 1, which damping agents are arranged in the intermediate spaces of the winding wires.

Further embodiments merely have a part of the described features, with any combination of features being provided, especially also of different described embodiments.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A musical string, comprising:
at least one supporting core of the string; and
a first winding wire wound in a helical manner around the core of the string, said first winding wire having a core and a first outside layer disposed in substantial surrounding relationship to the core,
wherein the core and the first outside layer are pressed and/or welded together at least in sections.

2. The musical string of claim 1 for use in string or plucked instruments.

3. The musical string of claim 1, wherein the core and the first outside layer are pressed and/or welded together at least in sections by a mechanical forming process.

4. The musical string of claim 3, wherein the forming process includes plating and/or drawing and/or rolling.

5. The musical string of claim 1, further comprising at least one second outside layer in substantial surrounding relationship to the first outside layer.

6. The musical string of claim 5, wherein the second outside layer is pressed and/or welded together at least in sections with the first outside layer.

7. The musical string of claim 5, wherein the first outside layer and the second outside layer are pressed and/or welded together at least in sections by a mechanical forming process.

8. The musical string of claim 7, wherein the forming process includes plating and/or drawing and/or rolling.

9. The musical string of claim 1, further comprising a polymer arranged in sections between the core and the first outside layer and/or between the first outside layer and the second outside layer.

10. The musical string of claim 9, wherein the polymer is a lacquer and/or a resin.

11. The musical string of claim 5, wherein at least one of the first and second outside layers has a thickness ranging between 8 μm and 300 μm.

12. The musical string of claim 5, wherein at least one of the first and second outside layers has a thickness ranging between 10 μm and 100 μm.

13. The musical string of claim 5, wherein at least one of the first and second outside layers has a thickness ranging 25 μm and 70 μm.

14. The musical string of claim 1, wherein the core comprises at least one metal selected from the group of aluminum, nickel, copper, tungsten, iron, lead, thallium, titanium, silver, iridium.

15. The musical string of claim 1, wherein the core comprises at least one shape memory alloy and/or expansion alloy.

16. The musical string of claim 1, wherein the core comprises at least one plastic selected from the group of PA, PMMA, PE, PP, ABS, PVC, POM, PEEK, PTFE, FUR, PC, CA, CAB, PET, PETP, PS, SB, SAN.

17. The musical string of claim 1, wherein the core comprises a granulate which includes plastic and/or metal.

18. The musical string of claim 17, wherein the granulate comprises at least one capsule having an interior, and at least one fluid arranged in the interior of the capsule.

19. The musical string of claim 18, wherein the capsule is a micro-container and/or a nano-container.

20. The musical string of claim 18, wherein the fluid is a polymer fluid.

21. The musical string of claim 5, wherein at least one of the first and second outside layers comprises at least one metal selected from the group of aluminum, gold, silver, rhodium, palladium, platinum, rhenium, tantalum, titanium, nickel.

22. The musical string of claim 5, wherein at least one of the first and second outside layers comprises at least one shape memory alloy and/or an expansion alloy.

23. The musical string of claim 1, wherein the core comprises a predeterminable number of fibrous and/or wire-like core elements.

24. The musical string of claim 1, wherein the core is configured as a rope.

25. The musical string of claim 1, wherein the core has a polygonal cross-section.

26. The musical string of claim 1, wherein at least a section of the core comprises an electrically and/or chemically applied coating.

27. The musical string of claim 1, wherein the first winding wire is configured as a round wire.

28. The musical string of claim 1, wherein the first winding wire has a cross section having at least one substantially straight section.
